(19) United States
(12) Patent Application Publication
(10) Pub. No.: US 2011/0249103 A1
(43) Pub. Date: Oct. 13, 2011

(54) 3D GLASSES AND METHOD OF CONTROLLING THE SAME

(75) Inventor: Osamu Taniguchi, Chigasaki-shi (JP)

(73) Assignee: CANON KABUSHIKI KAISHA, Tokyo (JP)

(21) Appl. No.: 13/041,830

(22) Filed: Mar. 7, 2011

(30) Foreign Application Priority Data
Apr. 7, 2010 (JP) 2010-088481

(51) Int. Cl. H04N 13/04

(52) U.S. Cl. 348/56; 348/E13.075

(57) ABSTRACT

In a field sequential 3D image viewing system, 3D glasses are provided for use with a plurality of types of image control apparatuses. A storage unit stores opening control data associated with timing of opening right and left shutters of the 3D glasses in relation to each type of the image control apparatus. A signal processing unit generates an opening signal for driving the shutters based on the switching signal associated with the right and left shutters and based the opening control data read from the storage unit. The right and left shutters are driven according to the opening signal. The start time and open duration of the opening signal may be set based on the type of image control apparatus.

### BACKGROUND OF THE INVENTION

1. Field of the Invention

The present invention relates to a viewing device and a method of controlling such a device for viewing a displayed 2D image as a 3D image; more particularly, the present invention relates to 3D glasses that enable a viewer to perceive a 2D image as 3D image and a method of controlling such 3D glasses.

2. Description of the Related Art

In a three-dimensional (3D) image viewing system, a two-dimensional (2D) right-eye image and a 2D left-eye image are alternately displayed on an image display apparatus in a time-sharing manner. These images are viewed via 3D glasses whose right and left shutters are alternately opened and closed in synchronization with the alternated display (switching) of the right-eye image and the left-eye image thereby allowing a 3D image to be viewed. In such a field sequential 3D image viewing system, the 3D glasses are generally dedicated to be used with a specific display apparatus. However, with the growing popularity of 3D television, there is a growing need for universal 3D glasses that can be seamlessly used with a plurality of types of display apparatuses.

Japanese Patent Laid-Open No. 11-098537 discloses 3D glasses configured such that light is polarized through a right-eye liquid crystal by an amount different by 90° from an amount by which light is polarized through a left-eye liquid crystal. This type of 3D glasses can be used with a shutter-type 3D display system and a polarization-type 3D display system. Japanese Patent Laid-Open No. 2009-302770 discloses a 3D image display system in which an apparatus-type mark displayed on a display screen is detected by 3D glasses and timings of opening/delaying shutters of shutter glasses and opening durations thereof are adjusted according to the apparatus type indicated by the apparatus-type mark.

In the conventional 3D image viewing systems, the timing of displaying an image on a screen and the timing of opening/closing the shutters of the 3D glasses are optimized for each type of display apparatus. Therefore, when 3D glasses optimized for a particular type of display apparatus are used to view an image displayed on a different type of display apparatus, a difference in optimum timings between the 3D glasses and the display apparatus may make it difficult to enjoy viewing a good 3D image.

### SUMMARY OF THE INVENTION

A first aspect of the present invention relates to 3D glasses comprising right and left shutters that are alternately opened and closed in synchronization with switching between a right-eye image and a left-eye image alternately displayed in a time-sharing manner on an image display unit under the control of an image control apparatus such that the right-eye image and the left-eye image are viewed as a 3D image; the 3D glasses include a receiving unit configured to receive a switching signal in synchronization with switching between the right-eye image and the left-eye image from the image control apparatus, a storage unit configured to store opening control data associated with timing of opening the shutters in relation to a type of the image control apparatus, a signal processing unit configured to generate an opening signal for driving the shutters based on the switching signal and the opening control data, and a driving unit configured to drive the shutters in accordance with the opening signal.

In the first aspect of the present invention, the timing of opening and closing the shutters of the 3D glasses are adjustable depending on a specific type of a 3D image control apparatus so that the 3D glasses are adaptable to a plurality of types of 3D image control apparatuses.

Further features of the present invention will become apparent from the following description of exemplary embodiments with reference to the attached drawings.

### BRIEF DESCRIPTION OF THE DRAWINGS

FIGS. 1A and 1B are block diagrams illustrating a 3D image viewing system according to an embodiment of the present invention.

FIGS. 2A to 2F are timing charts illustrating timings of opening shutters of shutter glasses according to an embodiment of the present invention.

FIGS. 3A to 3C are diagrams illustrating a relationship between a shutter opening signal applied to shutter glasses and a response of a shutter thereto.

FIGS. 4A and 4B are diagrams illustrating shutter glasses and a configuration of dip switches.

FIGS. 5A and 5B are diagrams illustrating a charging system of shutter glasses.

### DESCRIPTION OF THE EMBODIMENTS

### First Embodiment

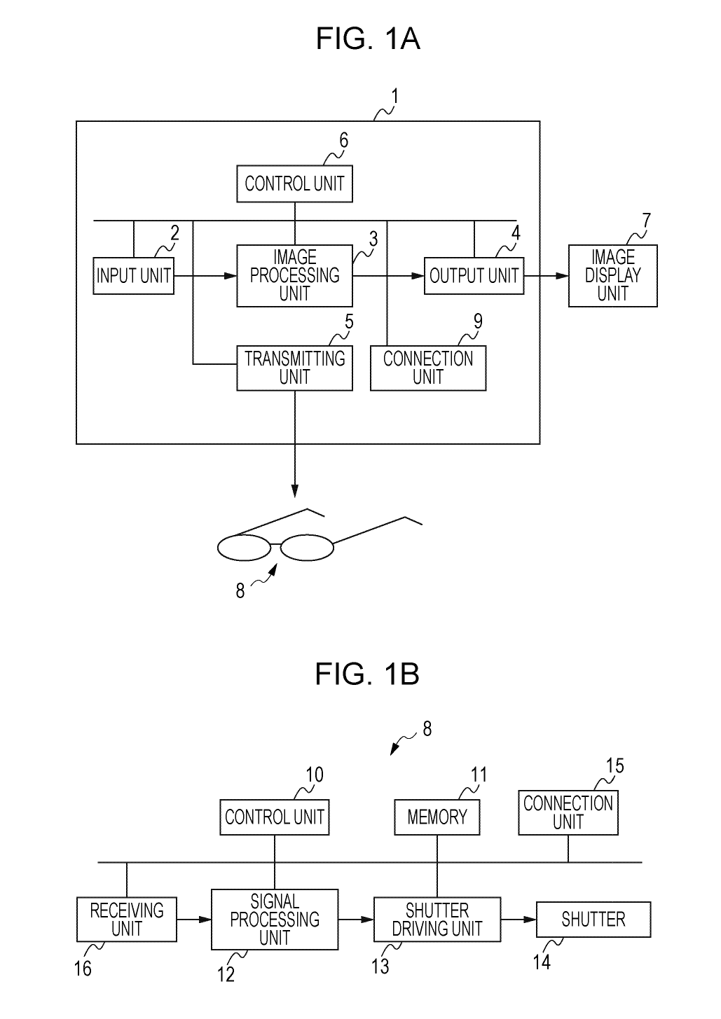

The present invention is described in further detail below with reference to embodiments in conjunction with the accompanying drawings. FIGS. 1A and 1B are block diagrams illustrating a 3D image viewing system according to an embodiment of the present invention. As shown in these conceptual diagrams, a simplified version of the 3D image viewing system includes a 3D image control apparatus (hereinafter referred to simply as a control apparatus) 1, an image display unit (hereinafter referred to simply as a display unit) 7, and a pair of shutter glasses (hereinafter referred to simply as glasses) serving as 3D glasses 8.

FIG. 1A is a block diagram illustrating the control apparatus 1. FIG. 1B is a diagram showing the relation between parts of the 3D glasses 8. The control apparatus 1 may be, for example, a video recorder, a video player, a set-top box (STB), a 3D television set integrated with a display unit 7, or any equivalent device.

An input unit 2 receives data to be displayed, such as a digital television broadcast signal, content data supplied via a network, or content data via a video medium. The input unit 2 transmits the received data in the form of an image signal (hereinafter referred to as a “3D image signal”) to an image processing unit 3. The input unit 2 includes a receiving unit such as a tuner, a digital interface, or the like that receives the data to be displayed. Based on the 3D image signal, the image processing unit 3 generates a left-eye image signal, a right-eye image signal, and a shutter-glasses switching control signal (hereinafter referred to simply as a switching signal). The switching signal is transmitted from a transmitting unit 5 to a receiving unit 16 of 3D glasses 8 using an infrared communication medium or a wireless communication medium. In the 3D glasses 8, left and right shutters are alternately opened and closed in synchronization with (in response to) the switching signal. An output unit 4 produces luminance data for use in displaying a 3D image according to specifications of the display unit 7 based on the left-eye image signal and the right-eye image signal. The display unit 7 displays the right-eye image and the left-eye image according to the luminance data such that the right-eye image and the left-eye image are alternately displayed every field in a time sharing manner. The control unit 6 controls the control blocks in the control apparatus 1 such that the control blocks operate cooperatively.

FIG. 1B is a block diagram associated with the 3D glasses 8. A memory 11 (storage unit) stores opening control data for each of apparatus type codes corresponding to respective apparatus types of the control apparatus 1. A control unit 10 reads opening control data associated with the shutter opening timing from the memory 11 when a power switch of the 3D glasses 8 is turned on, and the control unit 10 outputs the opening control data to a signal processing unit 12. The reading of the opening control data may be performed when a receiving unit 16 receives a switching signal.

The signal processing unit 12 generates right and left shutter opening signals (hereinafter referred to simply as opening signals) based on the switching signal received by the receiving unit 16 and the opening control data read from the memory 11. A shutter driving unit 13 drives the right and left liquid crystal shutter 14 in synchronization with the opening signal.

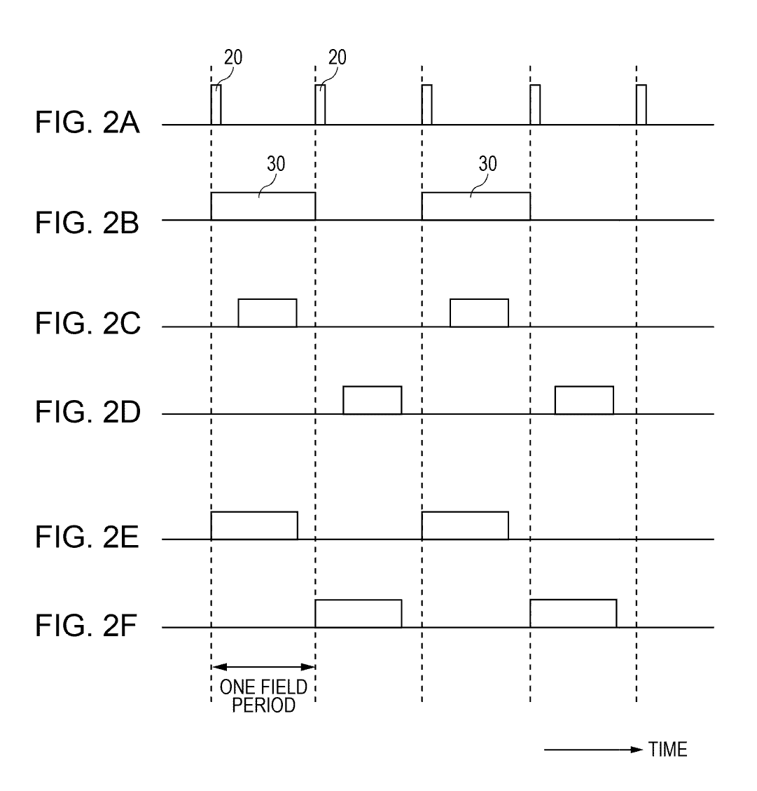

FIGS. 2A to 2F are timing charts illustrating output timings of a vertical synchronization signal output from the image processing unit 3, the switching signal output from the transmitting unit 5, and the opening signals generated by the 3D glasses 8. As shown in FIG. 2A, a vertical synchronization signal 20 is output in each field period in which either the left-eye image signal (e.g., FIG. 2C or 2E) or the right-eye image signal (e.g., FIG. 2D or 2F) is output. Note that two field periods form one frame that provides a complete both-eye image (i.e., one 3D image).

The switching signal for each of the left and right shutter 14 is alternately generated by the image processing unit 3 based on the vertical synchronization signal 20 (FIG. 2A) and is output according to predetermined timings 30 as shown in FIG. 2B regardless of the type of the control apparatus 1. The opening signals shown in FIGS. 2C to 2F are synchronous with the opening start times and the open durations of the right and left shutters. Note that the opening signals vary depending on the type of the control apparatus 1. For example, FIGS. 2C and 2D show opening signals #1 for each of the left and right shutter 14 corresponding to an apparatus-type #1 in which a liquid crystal display (LCD) panel is used as the display unit 7. FIGS. 2E and 2F show opening signals #2 for each of the left and right shutter 14 corresponding to an apparatus-type #2 in which a plasma display panel (PDP) is used as the display unit 7. Any other apparatus-type that can be used as the display unit 7 can be synchronized in this manner with the opening start times and the open durations of the right and left shutters of 3D glasses 8.

The apparatus type of the control apparatus 1 includes two items of information. A first item of information is information specified via the classification performed based on the type of the display unit 7. The type of the display unit 7 is defined by the type (LCD, PDP, etc.) of the display panel, the number of pixels, and a frame rate. A second item of information is information that designates the type of the control apparatus 1 or a production name of the control apparatus 1.

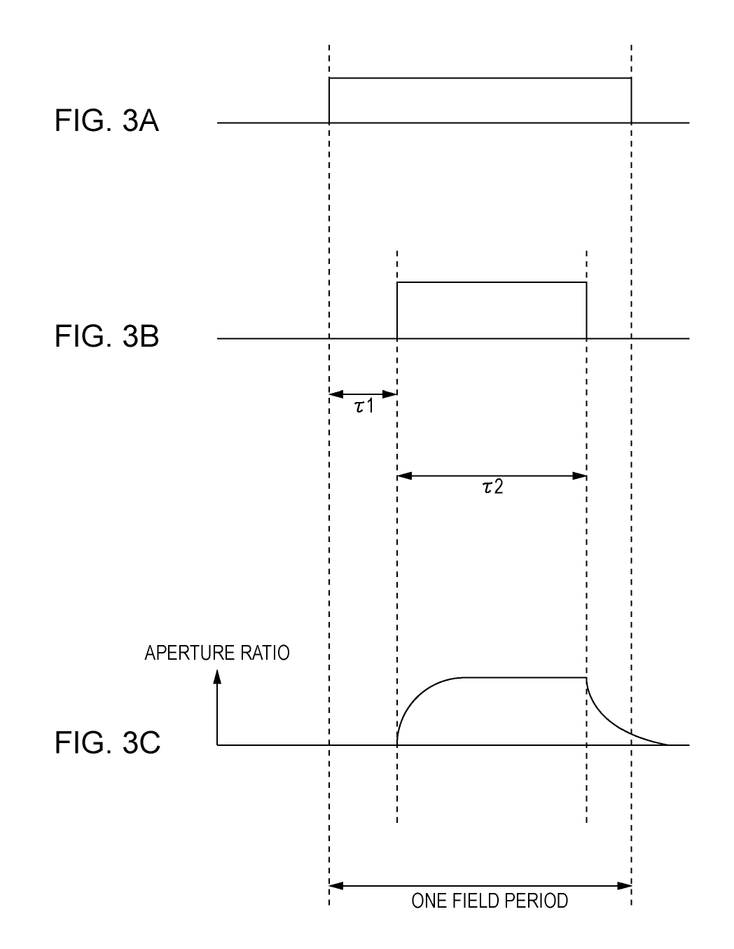

FIGS. 3A to 3C illustrate a switching signal (FIG. 3A), a right shutter opening signal (FIG. 3B), and a response of the right shutter (FIG. 3C). The shutter starts to open in synchronization with rising of the opening signal and starts to close in synchronization with falling of the opening signal. According to a setting performed by a user manually or performed automatically via a type recognition process, the control unit 10 of the 3D glasses 8 reads the opening control data from the memory 11 and sets, in the signal processing unit 12, the opening start time τ1 of the opening signal #1 with respect to the switching signal and the open duration τ2. The signal processing unit 12 generates the opening signal (FIG. 3B) with the opening start time τ1 and the open duration τ2 and outputs the generated opening signal to the shutter driving unit 13. In synchronization with the received opening signal, the shutter driving unit 13 drives the liquid crystal shutter 14. The 3D glasses 8 operate in a similar manner for the left shutter. Thus, the timing operation of only one shutter is described here to avoid unnecessary duplication.

The display unit 7 includes, for example, 1080×1920 pixels and is subjected to field scanning at 240 Hz. A field period Tf is equal to about 4 msec.

When an LCD is used as the display unit 7, the liquid crystal of the LCD may be slower in response than the liquid crystal shutter 14. To reduce crosstalk of images to a level that allows a user to enjoy viewing a 3D image without feeling significantly uncomfortable, the opening start time τ1 and the open duration τ2 may be set as follows.

Tf/4≦τ1≦Tf/2

Tf/4≦τ2≦3Tf/4

In a case where a PDP is used as the display unit 7, no crosstalk occurs in images. In this case, to suppress an overlap in opening duration between the right and left shutters, the opening start time τ1 and the open duration τ2 may be set as follows.

0≦τ1≦Tf/8

3Tf/4≦τ2≦Tf

That is, in the case of the PDP, τ1 may be set to be smaller than for the LCD, and τ2 may be set to be greater than for the LCD. It is a matter of course, therefore, that the opening start time τ1 and the open duration τ2 may be set based on the scanning field period Tf of the type of display apparatus.

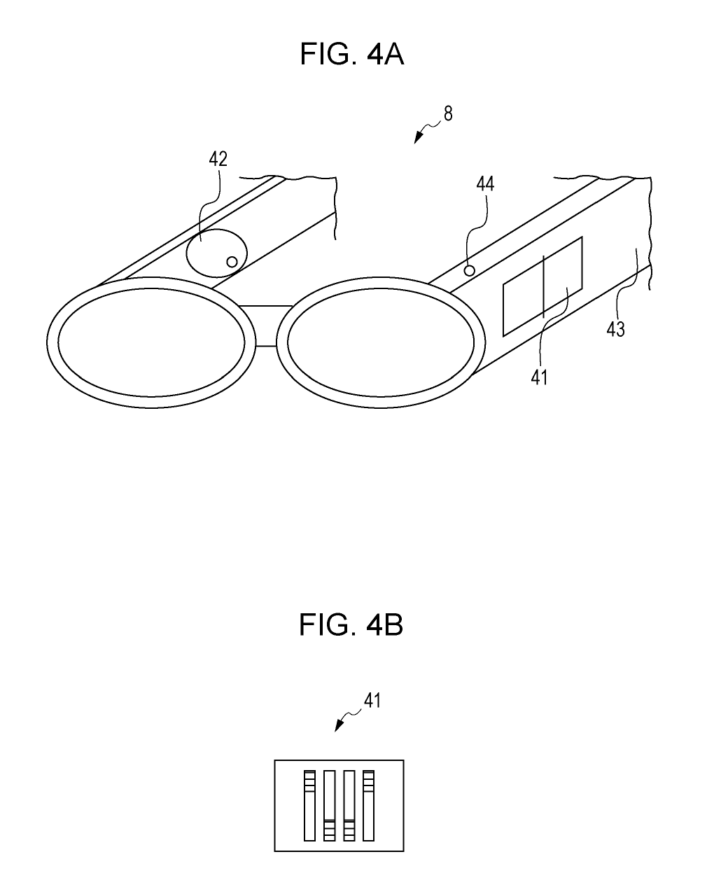

FIG. 4A illustrates an overview of the 3D glasses 8. FIG. 4B illustrates a configuration of dip switches 41 disposed on a side of a frame 43 of the 3D glasses 8. A user is allowed to set a 4-digit code by turning up or down the four dip switches 41 to represent the apparatus-type code of the control apparatus 1. The apparatus-type code may be acquired from a list/table indicating the correspondence between apparatus/model names and apparatus-type codes. The apparatus-type code list/table may be distributed to users in printed form with or without the product, or may be acquired by accessing, for example, an electronic publication made available in a particular site via a network. The apparatus-type code information stored in the control apparatus 1 may be displayed in a graphic representation so that a user can know the apparatus-type code. In the memory 11, the opening control data associated with the opening start time τ1 and the open duration τ2 is stored in relation to the apparatus-type code. The control unit 10 reads from the memory 11 the opening control data corresponding to the apparatus-type code indicated by the dip switches 41. The dip switches 41 are normally covered with a slide cover with the same color as that of the frame 43. A coin-type lithium battery 42 inserted in the frame, on a side opposite to the location of the dip switches 41, is used as a power supply for the 3D glasses 8.

A rewritable ROM is used as the memory 11. The data stored in the ROM can be rewritten as required at a shop so as to adapt to a new product. Updating of the data stored in the ROM is also possible by connecting a connection terminal 44 of the 3D glasses 8 to a connection unit 9 of the control apparatus 1 via a cable and transferring data according to a particular communication format. In this case, the control apparatus 1 acquires a newest apparatus-type code via a broadcast signal or the Internet, as required. The acquired apparatus-type code is input to the 3D glasses 8 via the connection unit 15 according to a particular application installed on the control apparatus 1 thereby updating the data in the ROM.

### Second Embodiment

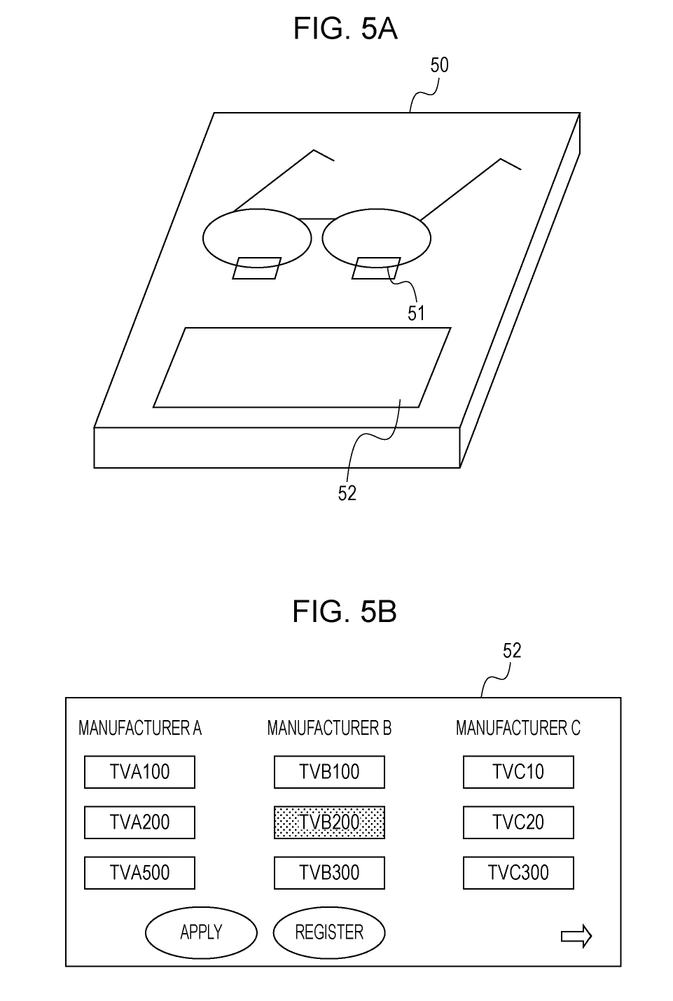

In a second embodiment, a rechargeable battery is used as a power supply for the 3D glasses 8. FIG. 5A schematically illustrates a charging unit 50 for charging the rechargeable battery. FIG. 5B illustrates an example of a manner in which information is displayed on a display unit 52 provided on the charging unit 50.

The charging unit 50 is connected to an AC power supply (not shown). The rechargeable battery can be charged in a state in which a contact pad provided on a lower part of the frame 43 surrounding the shutter part of the 3D glasses 8 is in contact with a contact pad 51 of the charging unit 50. The charging unit 50 is capable of transmitting an apparatus-type code to the 3D glasses 8 via a contact pad provided separately from a power transmission contact pad. Alternatively, near field communication may be used to transmit the apparatus-type code to the 3D glasses 8 put on the charging unit 50.

The apparatus-type code may be selected from a list of apparatus/model names of each manufacturer displayed on a touch panel as shown in FIG. 5B (in the example shown in FIG. 5B, TVB200 of a manufacturer B is selected). If an APPLY button is pressed, an apparatus-type code corresponding to the selected apparatus/model name is transmitted to the 3D glasses 8 and stored in the memory 11. If a REGISTER button is pressed, the specified apparatus-type code is registered in a memory in the charging unit 50 or only already registered apparatus types may be displayed.

Instead of transmitting the apparatus-type code from the charging unit 50 to the 3D glasses 8, opening control data may be transmitted. The opening control data for each apparatus type is stored in advance in the memory of the charging unit 50. In this case, the opening control data of all apparatuses/models of the control apparatus 1 does not need to be stored in the memory 11 in the 3D glasses 8, and thus it is possible to reduce the circuit size, which allows a reduction in weight of the 3D glasses 8.

### Other Embodiments

In the first and second embodiments described above, a user sets the type of the apparatus to be used by a manual operation. Alternatively, the apparatus-type code may be automatically set based on a received switching signal. In most cases, the switching signal is transmitted from the control apparatus 1 in such a manner that a carrier signal with a frequency higher than the frequency of the switching signal is modulated by a particular pattern and a resultant signal is transmitted. In the case of infrared communication using an LED as a light source, the carrier frequency is 20 kHz to 50 kHz. Apparatus-type codes are related in advance to modulation patterns of the carrier signal. In a blinking period in which the LED with the carrier frequency is blinked in synchronization with the switching signal, on/off-periods are controlled according to a particular format (for example, a NEC format) to describe the apparatus-type code in the form of 4-bit data.

The control unit 10 of the 3D glasses 8 is capable of identifying the apparatus-type code of the sender by identifying the modulation pattern of the carrier signal of the received infrared ray. When a switching signal is received after the power switch of the 3D glasses 8 is turned on, the control unit 10 reads opening control data corresponding to the identified apparatus-type code from the memory 11 and outputs the read opening control data to the signal processing unit 12.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-088481 filed Apr. 7, 2010, which is hereby incorporated by reference herein in its entirety.

What is claimed is:

1. 3D glasses comprising right and left shutters that are alternately opened and closed in synchronization with switching between a right-eye image and a left-eye image alternately displayed in a time-sharing manner on an image display unit under the control of an image control apparatus such that the right-eye image and the left-eye image are viewed as a 3D image, the 3D glasses comprising:
a receiving unit configured to receive a switching signal in synchronization with switching between the right-eye image and the left-eye image from the image control apparatus;
a storage unit configured to store opening control data associated with timing of opening the shutters in relation to a type of the image control apparatus;
a signal processing unit configured to generate an opening signal for driving the shutters based on the switching signal and the opening control data; and
a driving unit configured to drive the shutters in accordance with the opening signal.

2. The 3D glasses according to claim 1, wherein the opening control data is data associated with an opening start time and an open duration of the shutters.

3. The 3D glasses according to claim 1, wherein the storage unit stores the opening control data for each of apparatus-type code related to the respective apparatus types of the image control apparatus, and
wherein the 3D glasses further comprise a control unit configured to read, according to a specified timing, opening control data corresponding to a specified apparatus-type code from the storage unit.

4. The 3D glasses according to claim 3, wherein the apparatus-type code is set by a user by operating a switch unit.

5. The 3D glasses according to claim 3, wherein
the switching signal is received as a signal generated by modulating a carrier signal by a predetermined pattern, and
the control unit identifies a modulation pattern of the carrier signal and sets an apparatus-type code related to the identified modulation pattern.

6. The 3D glasses according to claim 1, wherein an start time and open duration of the opening signal is set based on the type of image control apparatus.

7. The 3D glasses according to claim 1, wherein an opening start time and an open duration of the opening signal are set based on a scanning field period of the type of display apparatus.

8. The 3D glasses according to claim 1, wherein an opening start time τ1 and an open duration τ2 of the opening signal set based on an scanning field period Tf of the type of display apparatus satisfy the following conditions:
Tf/4≦τ1≦Tf/2
Tf/4≦τ2≦3Tf/4.

9. The 3D glasses according to claim 1, wherein an opening start time τ1 and an open duration τ2 of the opening signal set based on an scanning field period Tf of the type of display apparatus satisfy the following conditions:
0≦τ1≦Tf/8
3Tf/4≦τ2≦Tf.

10. A method of controlling 3D glasses comprising right and left shutters that are alternately opened and closed in synchronization with switching between a right-eye image and a left-eye image alternately displayed in a time-sharing manner on an image display unit under the control of an image control apparatus such that the right-eye image and the left-eye image are viewed as a 3D image, the method comprising:
receiving a switching signal in synchronization with switching between the right-eye image and the left-eye image from the image control apparatus;
generating an opening signal for driving the shutters based on opening control data associated with a timing of opening the shutters and based on the switching signal, the opening control data being related to an apparatus type of the image control apparatus; and
driving the shutters based on the opening signal.
